(19) United States
(12) Patent Application Publication
(10) Pub. No.: US 2020/0272268 A1
(43) Pub. Date: Aug. 27, 2020

(54) DISPLAY APPARATUS AND CONTROLLING METHOD THEREOF

(71) Applicant: SAMSUNG ELECTRONICS CO., LTD., Suwon-si (KR)

(72) Inventors: Soyoung SHIN, Suwon-si (KR); Hyunsoo YUK, Suwon-si (KR); Soyoung JUNG, Suwon-si (KR); Sangjin HAN, Suwon-si (KR)

(73) Assignee: SAMSUNG ELECTRONICS CO., LTD., Suwon-si (KR)

(21) Appl. No.: 16/774,503

(22) Filed: Jan. 28, 2020

(30) Foreign Application Priority Data
Feb. 26, 2019 (KR) 10-2019-0022748

(51) Int. Cl. G06F 3/041; G06F 3/0488; G06F 3/0485

(52) U.S. Cl. CPC G06F 3/0412; G06F 3/0485; G06F 3/04886; G06F 3/0416

(57) ABSTRACT

A display apparatus is provided. The display apparatus includes a touch display and a processor configured to display a plurality of menu items on the touch display, based on receiving a touch input to one item among the plurality of menu items, identify a touch area on the touch display corresponding to the touch input, identify an information depth based on the identified touch area, and perform control to display content corresponding to the one item in a layout corresponding to the identified information depth.

### CROSS-REFERENCE TO RELATED APPLICATIONS

This application is based on and claims priority under 35 U.S.C. § 119 to Korean Patent Application No. 10-2019-0022748, filed on Feb. 26, 2019, in the Korean Intellectual Property Office, the disclosure of which is incorporated herein by reference in its entirety.

### BACKGROUND

### Field

The disclosure relates to a display apparatus and a controlling method thereof. More specifically, the disclosure relates to a display apparatus that changes a layout in consideration of a touch area and a controlling method thereof.

### Description of the Related Art

A display apparatus receiving a touch input of a user identifies a touch location by using pressure corresponding to a touch input of a user and performs a control operation corresponding to the touch location. Specifically, a general display apparatus can perform different control operations in consideration of the touch location and the number of touches of a user.

A controlling method of a general display apparatus as described above merely considers a touch location and the number of touches, and only a click or a double click can be distinguished. Therefore, a user has to click a separate control button or a user interface (UI) for a control function to perform various control operations and thus may feel inconvenient.

A user skilled in using a display apparatus may use a shortcut key of a keyboard to quickly perform various control operations. However, when the user tries to control a display apparatus only through a touch input without connecting a keyboard, there may be a problem that a function corresponding to the shortcut key may not be performed.

Also, when a separate UI corresponding to the shortcut key is displayed on a screen, the user can quickly perform a specific control operation by clicking on a separate UI. However, in this case, the user may need time to find the UI to be used by the user. In addition, when the size of a particular UI is small, the user may have a difficulty in clicking on a particular UI.

### SUMMARY

Embodiments may overcome the above disadvantages and other disadvantages not described above. Also, an embodiment is not required to overcome the disadvantages described above, and an embodiment may not overcome any of the problems described above.

Provided is a display apparatus that determines a layout displayed on a display in consideration of a touch area corresponding to a touch input and a controlling method thereof.

According to an embodiment, a display apparatus includes a touch display and a processor configured to display a plurality of menu items on the touch display, based on receiving a user's touch input to one item among the plurality of menu items, identify a touch area on the touch display corresponding to the touch input, identify an information depth for displaying a content corresponding to the one item based on the identified touch area, and perform control to display the content corresponding to the one item in a layout corresponding to the identified information depth.

The processor may, based on the touch area being less than a threshold value, perform control to display content corresponding to the one item in a first layout corresponding to a first depth, based on the touch area being greater than or equal to the threshold value, perform control to display a content corresponding to the one item in a second layout corresponding to a second depth, and a number of the content displayed in the second layout may be different from a number of the content displayed in the first layout.

The processor may control the touch display to display a guide user interface (UI) for guiding provision of a content in a different layout according to a touch area for an area in which the plurality of menu items are displayed.

The processor is configured to, based on the one item being a calendar item, in response to the touch area being less than a first threshold value, perform control to display a daily content in a first layout corresponding to a first depth, in response to the touch area being greater than or equal to the first threshold value and less than a second threshold value, perform control to display a weekly content in a second layout corresponding to a second depth, and in response to the touch area being greater than or equal to the second threshold value, perform control to display a monthly content in a third layout corresponding to a third depth.

The processor is configured to, based on the one item being a content list item, in response to the touch area being less than a first threshold value, perform control to display a text list for a plurality of contents in a first layout corresponding to a first depth, in response to the touch area being greater than or equal to the first threshold value and less than a second threshold value, perform control to display a thumbnail and title information of the plurality of contents, and in response to the touch area being greater than or equal to the second threshold value, perform control to display an image of the plurality of contents in a third layout corresponding to a third depth.

The processor is configured to, based on the one item being a content list item, in response to the touch area being less than a first threshold value, perform control to display a content file list in a first layout corresponding to a first depth, in response to the touch area being greater than or equal to the first threshold value and less than a second threshold value, perform control to display a lower folder list in the second layout corresponding to a second depth, and in response to the touch area being greater than or equal to the second threshold value, perform control to display an upper folder list in a third layout corresponding to a third depth.

The processor is configured to perform control to display a fewer number of content as a size of the touch area increases.

The user's touch input is a first touch input, and the processor is configured to display a user interface to change a layout that corresponds to the identified information depth, and based on receiving a second touch input of the user on the user interface, identify a touch area that corresponds to the second touch input and change the layout based on a touch area that corresponds to the second touch input.

The processor is configured to, based on a touch shape that corresponds to the touch input being a palm shape, identify a user's body size based on the identified touch area, identify a position on a display on which the content is to be displayed based on the identified body size, and perform control to display the content in a layout corresponding to the identified information depth on the identified position on the display.

The touch input of the user is a first touch input, and the processor is configured to, based on receiving a second touch input of the user, identify left and right hand information corresponding to the second touch input and a touch area corresponding to the second touch, identify a scroll direction based on the identified left and right hand information, identify a scroll speed based on a touch area corresponding to the second touch input, and change a screen displayed based on the identified scroll direction and scroll speed.

A controlling method of a display apparatus according to an embodiment, the method includes displaying a plurality of menu items on a touch display; based on receiving a user's touch input to one item among the plurality of menu items, identifying a touch area corresponding to the touch input; identifying an information depth for displaying a content corresponding to the one item based on the identified touch area; and displaying content corresponding to the one item in a layout corresponding to the identified information depth.

The displaying the content may include, based on the touch area being less than a threshold value, displaying content corresponding to the one item in a first layout corresponding to a first depth, based on the touch area being greater than or equal to the threshold value, displaying a content corresponding to the one item in a second layout corresponding to a second depth, and a number of the content displayed in the second layout may be different from a number of the content displayed in the first layout.

The method may further include displaying a guide user interface (UI) for guiding provision of content in a different layout according to a touch area for an area in which the plurality of menu items are displayed.

The displaying the content may include, based on the one item being a calendar item, in response to the touch area being less than a first threshold value, displaying a daily content in a first layout corresponding to a first depth, in response to the touch area being greater than or equal to the first threshold value and less than a second threshold value, displaying a weekly content in a second layout corresponding to a second depth, and in response to the touch area being greater than or equal to the second threshold value, displaying a monthly content in a third layout corresponding to a third depth.

The displaying the content may include, based on the one item being a content list item, in response to the touch area being less than a first threshold value, displaying a text list for a plurality of contents in a first layout corresponding to a first depth, in response to the touch area being greater than or equal to the first threshold value and less than a second threshold value, displaying a thumbnail and title information of the plurality of contents, and in response to the touch area being greater than or equal to the second threshold value, displaying an image of the plurality of contents in a third layout corresponding to a third depth.

The displaying the content may include, based on the one item being a content list item, in response to the touch area being less than a first threshold value, displaying a content file list in a first layout corresponding to a first depth, in response to the touch area being greater than or equal to the first threshold value and less than a second threshold value, displaying a lower folder list in the second layout corresponding to a second depth, and in response to the touch area being greater than or equal to the second threshold value, displaying an upper folder list in a third layout corresponding to a third depth.

The displaying the content may include displaying a fewer number of content as a size of the touch area increases.

The user's touch input may be a first touch input, and the displaying the content may include displaying a user interface to change a layout that corresponds to the identified information depth and, based on receiving a second touch input of the user on the user interface, identifying a touch area that corresponds to the second touch input and changing the layout based on a touch area that corresponds to the second touch input.

The method may further include, based on a touch shape that corresponds to the touch input being a palm shape, identifying a user's body size based on the identified touch area, identifying a position on a display on which the content is to be displayed based on the identified body size, and displaying the content in a layout corresponding to the identified information depth on the identified position on the display.

The touch input of the user may be a first touch input, and the method may further include, based on receiving a second touch input of the user, identifying left and right hand information corresponding to the second touch input and a touch area corresponding to the second touch, identifying a scroll direction based on the identified left and right hand information, identifying a scroll speed based on a touch area corresponding to the second touch input, and changing a screen displayed based on the identified scroll direction and scroll speed.

### BRIEF DESCRIPTION OF THE DRAWING FIGURES

The above and/or other aspects, features, and advantages of certain embodiments of the disclosure will be more apparent from the following description taken in conjunction with the accompanying drawings, in which:

FIG. 1 is a view to describe a display apparatus according to an embodiment;

FIG. 2 is a block diagram illustrating a display apparatus according to an embodiment:

FIG. 3 is a block diagram illustrating a detailed configuration of a display apparatus of FIG. 2;

FIG. 4 is a view to describe an operation of a display apparatus to identify a touch area;

FIG. 5 is a view to describe an operation of a display apparatus for providing a layout corresponding to a touch area;

FIG. 6 is a view to describe a guide UI for guiding provision of a layout in consideration of a touch area;

FIG. 7 is a view to describe an embodiment of providing a schedule layout in consideration of a touch area;

FIG. 8 is a view to describe an embodiment of providing a layout for a content list according to a touch area;

FIG. 9 is a view to describe a structured relation of a content list according to an embodiment;

FIG. 10 is a view to describe an embodiment of providing a layout for a content list in consideration of a touch area in a structured relation of FIG. 9;

FIG. 11 is a view to describe a still another embodiment of providing a layout for a content list in consideration of a touch area in a structured relation of FIG. 9;

FIG. 12 is a view to describe an embodiment of identifying body information of a user in consideration of a touch area and a touch shape corresponding to a touch input;

FIG. 13 is a view to describe an embodiment of providing a layout differently based on user's body information;

FIG. 14 is a view to describe an operation of a display apparatus for identifying left and right hand information based on user's touch input;

FIG. 15 is a view to describe an embodiment of providing a layout differently based on left and right hand information;

FIG. 16 is a view to describe a still another embodiment of providing a layout differently based on left and right hand information;

FIG. 17 is a view to describe an embodiment of providing a layout differently according to a touch area of a touch input and a moving direction of two hands; and

FIG. 18 is a flowchart to describe a controlling method of a display apparatus according to an embodiment.

### DETAILED DESCRIPTION OF THE EMBODIMENTS

Before specifically describing the disclosure, a method for demonstrating the present specification and drawings will be described.

Terms used in the present specification and the claims are general terms identified in consideration of the functions of the various embodiments of the disclosure. However, these terms may vary depending on intention, legal or technical interpretation, emergence of new technologies, and the like of those skilled in the related art. Also, there may be some terms arbitrarily identified by an applicant. Unless there is a specific definition of a term, the term may be construed based on the overall contents and technological common sense of those skilled in the related art.

Further, like reference numerals indicate like components that perform substantially the same functions throughout the specification. For convenience of descriptions and understanding, the same reference numerals or symbols are used and described in different embodiments. In other words, although elements having the same reference numerals are all illustrated in a plurality of drawings, the plurality of drawings do not mean one embodiment.

The terms such as “first,” “second,” and so on may be used to describe a variety of elements, but the elements should not be limited by these terms. The terms are used only for the purpose of distinguishing one element from another. For example, the elements associated with the ordinal numbers should not be limited in order or order of use by the numbers. If necessary, the ordinal numbers may be replaced with each other.

A singular expression includes a plural expression, unless otherwise specified. It is to be understood that the terms such as “comprise” or “consist of” are used herein to designate a presence of a characteristic, number, step, operation, element, component, or a combination thereof, and not to preclude a presence or a possibility of adding one or more of other characteristics, numbers, steps, operations, elements, components or a combination thereof.

These embodiments are capable of various modifications and have various embodiments, and specific embodiments are illustrated in the drawings and described in detail in the description. It should be understood, however, that it is not intended to limit the scope of the specific embodiments but includes all transformations, equivalents, and alternatives falling within the disclosed spirit and scope. When it is decided that a detailed description for the known art related to the disclosure may unnecessarily obscure the gist of the disclosure, the detailed description will be omitted.

The term such as “module,” “unit,” “part”, and so on is used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor.

Also, when any part is connected to another part, this includes a direct connection and an indirect connection through another medium. Further, when a certain portion includes a certain element, unless specified to the contrary, this means that another element may be additionally included, rather than precluding another element.

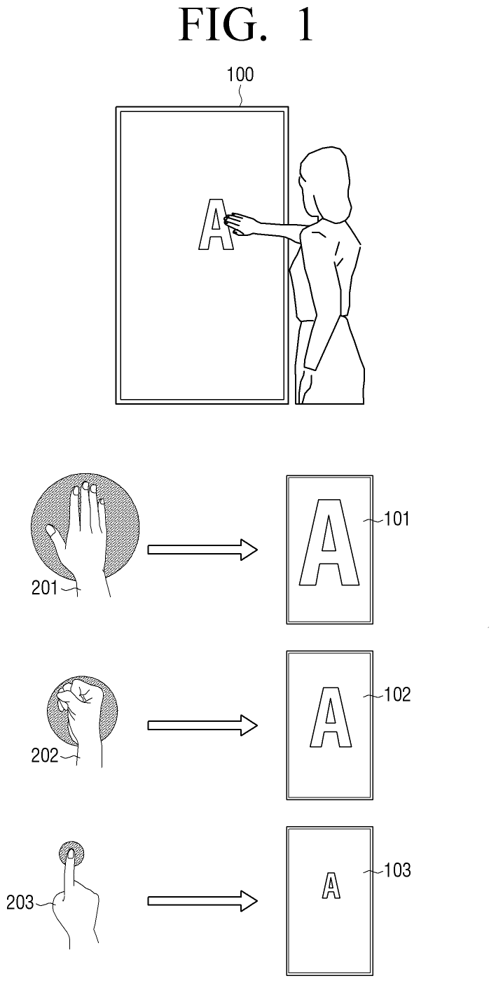

FIG. 1 is a view to describe a display apparatus according to an embodiment.

A display apparatus 100 may include various devices including a display. The display apparatus 100 may be an electronic board, TV, a desktop PC, a notebook, a smartphone, a tablet PC, a server, or the like. The above example is merely an example of describing an electronic apparatus and is not limited to the above device.

Referring to FIG. 1, the display apparatus 100 may include a display 110 capable of receiving a touch input of a user. In the disclosure, the display may mean a touch display.

The display apparatus 100 may recognize a user's touch input and provide a corresponding display screen. Specifically, the display apparatus 100 may receive a user's touch input and identify a touch area corresponding to the touch input. The touch area may be different depending on the user's touch input. For example, touch inputs such as a palm touch 201, a fist touch 202, a finger touch 203, or the like, may each be different in touch area. The display apparatus 100 can provide different screens in consideration of each touch area. The display apparatus 100 can adjust the size of the image (or UI) displayed on the display according to the touch area. For example, the larger the touch area, the larger the size of the image (or UI) displayed on the display. Specifically, when the display apparatus 100 identifies the user's touch input as the palm touch 201, a touch area corresponding to the palm touch 201 may be obtained and an image layout 101 corresponding to the touch area may be provided. Further, when the display apparatus 100 identifies the user's touch input as the fist touch 202, a touch area corresponding to the fist touch 202 may be obtained and an image layout 102 corresponding to the touch area may be provided. When the display apparatus 100 identifies the user's touch input as the finger touch 203, a touch area corresponding to the finger touch 203 may be obtained and an image layout 103 corresponding to the touch area may be provided.

The embodiment is not necessarily limited to the above embodiment. As another example, the larger the touch area is, the more the display apparatus 100 may reduce the size of an image (or UI) displayed on the display.

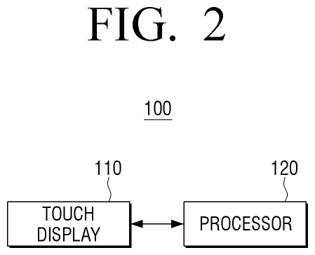

FIG. 2 is a block diagram illustrating a display apparatus according to an embodiment.

Referring to FIG. 2, the display apparatus 100 may include the touch display 110 and a processor 120.

The touch display 110 may be implemented as a display of various types such as a liquid crystal display (LCD), organic light emitting diodes (OLED) display, plasma display panel (PDP), or the like. For example, the touch display 110 may include a touch screen coupled to a touch sensor.

In the touch display 110, a backlight unit, a driving circuit which may be implemented as an a-si TFT, low temperature poly silicon (LTPS) TFT, organic TFT (OTFT), or the like, may be included as well. In the meantime, the touch display 110 may be implemented as a flexible display, a rollable display, a third-dimensional (3D) display, or the like. The processor 120 controls overall operations of the display apparatus 100. The processor 120 may be implemented as a digital signal processor (DSP), a microprocessor, and a time controller (TCON) for processing a digital image signal, but is not limited thereto. The processor 120 may include one or more among a central processing unit (CPU), a micro controller unit (MCU), a micro processing unit (MPU), a controller, an application processor (AP), a graphics-processing unit (GPU), a communication processor (CP), and an Advanced Reduced instruction set computing (RISC) Machine (ARM) processor or may be defined as a corresponding term. The processor 120 may be implemented in a system on chip (SoC) type or a large scale integration (LSI) type which a processing algorithm is built therein or in a field programmable gate array (FPGA) type. The processor 120 may perform various functions by executing computer executable instructions stored in the memory 130.

The processor 120 may display a plurality of menu items on the touch display 110.

Here, the menu item (or a UI) may be displayed as a graphical user interface (GUI) representing a menu, for example, at least one of an image or text representing a menu or content. The menu may be at least one of an item or a folder classified according to a category, and may include program items such as, but not limited to, an application or the like.

The processor 120, when a user's touch input is received on one item among a plurality of menu items, may identify a touch area corresponding to the touch input.

The touch input of the user may be divided into a palm touch, a hand's back touch, a fist touch, and a finger touch. In addition, the user's touch input may also include touching by an electronic pencil (or a touch pencil) without directly touching the touch display 110 by the user's body. Here, the fist touch may be divided into a first fist touch 202 or a second fist touch 204 depending on the direction of the holding the fist or the direction of contacting the fist on the touch surface, and may be divided into additional input as necessary.

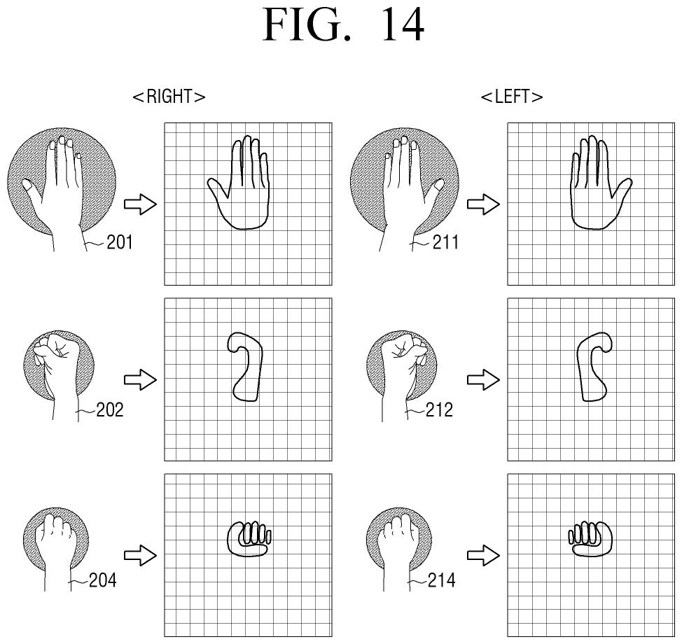

As another embodiment, the user's touch input may be distinguished into the left hand touch and the right hand touch, and the user input of distinguishing the left hand and the right hand will be described in FIG. 14 below.

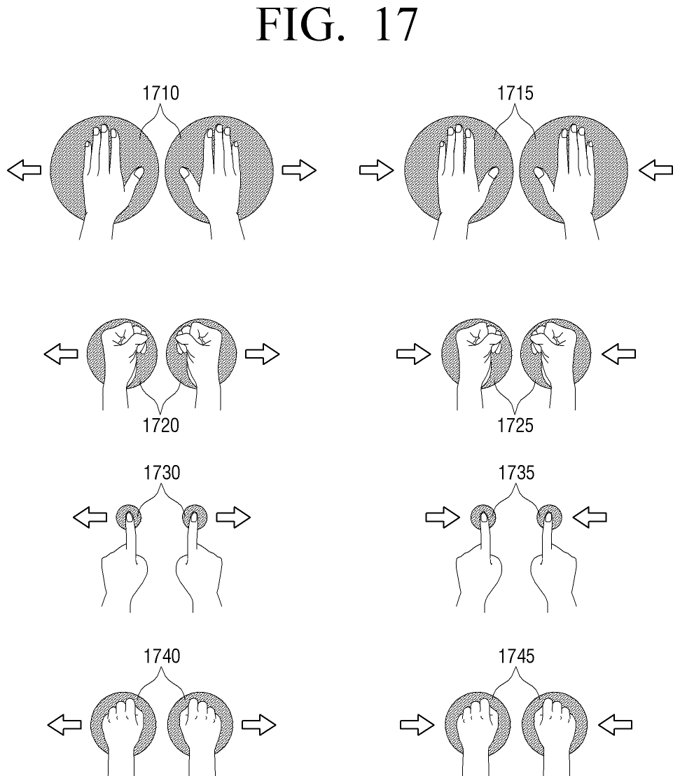

According to a still another embodiment, the user's touch input may distinguish two hand input by touching the left hand and the right hand at the same time, and may additionally consider a moving direction of two hand touch. Two hand touch input will be described in FIG. 17 below.

The processor 120, when the user's touch input is received, may identify a touch area corresponding to the user touch input. Specifically, the processor 120 may calculate a space of the contacted area by analyzing the contacted user input on the touch display 110.

The processor 120 may identify information depth for displaying a content corresponding to one item based on a touch area and control the display 110 to display a content with a layout corresponding to the identified information depth.

The processor 120 can identify a depth (or an information depth to display content) corresponding to one item selected by a user among the menu items in consideration of a touch area. The detailed information may mean a sub-folder or sub-content of a menu item. The depth (or information depth to display content) of the detailed information may be a criterion for determining which attribute information among the plurality of attribute information included by the detailed information is to be displayed. Further, the processor 120 can control the display 110 to display a layout indicating specific attribute information among the plurality of attribute information including detailed information based on the depth of the detailed information. For example, the menu item may refer to a top folder in accordance with an embodiment. As another example, a menu item may refer to a lower folder.

According to an embodiment, when a touch area of the processor 120 is less than a threshold value, content corresponding to one item may be displayed in a first layout corresponding to a first depth, and if the touch area is greater than or equal to a threshold value, the touch display may be controlled to display content corresponding to one item with a second layout corresponding to the second depth, and the number of content displayed in the second layout may be different from the number of content displayed in the first layout.

The first depth and the second depth may be predetermined identification criteria for distinguishing a range of detailed information. The range of the detailed information corresponding to the depth may mean the type of content or the number of content displayed on the touch display 110. The processor 120 may identify a layout corresponding to a different depth, and display content differently for each depth using each layout. The type of content or the number of content displayed on the touch display 110 may be different depending on the layout.

For example, when a schedule item is displayed on the touch display 110, the detailed information may include at least one of monthly schedule information (content), weekly schedule information (content), daily schedule information (content), and time unit schedule information (content). For example, if the touch area is less than a threshold value, the processor 120 can identify the depth corresponding to the touch area as the first depth, determine a layout corresponding to the first depth as a daily layout, and control the touch display 110 to display detailed information including daily schedule information corresponding to the daily layout as the first layout. When the touch area is greater than or equal to the threshold value, the processor 120 can identify that the depth corresponding to the touch area is the second depth, determine the layout corresponding to the second depth as the weekly layout, and control the touch display 110 to display the weekly schedule information corresponding to the weekly schedule layout corresponding to the weekly layout as the second layout. Here, the processor 120 may map the first depth to daily schedule information, or daily layout, and may prestore the mapping information in which the second depth is mapped to the weekly schedule information, or the weekly layout in the memory 130.

The processor 120 may control the touch display to display a guide UI for guiding that a content is provided in different layouts according to a touch area with respect to an area where a plurality of menu items are displayed.

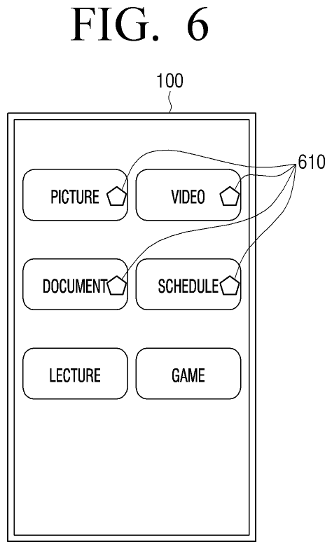

The guide UI may be a UI instructing that different layouts are provided according to a touch area when a menu item (or a specific folder) is touched. A shape of the guide UI may change according to user setting, and the guide UI may be displayed in the vicinity of the menu UI (or a specific folder). The description regarding the guide UI will be described in FIG. 6.

According to still another embodiment, when the user's touch input touches the guide UI, the processor 120 may control to display a different layout on the touch display 110 according to the touch area. When the user desires to display different layouts according to touch areas, the user may select the guide UI, and if the user desires to display a general layout (or an existing layout), an area where the guide UI is not displayed may be selected. In the case of distinguishing the user's intention through whether there has been a touch input in the guide UI, the display apparatus 100 may immediately perform a separate control operation of the user without spending time.

The processor 120 may apply different layout types according to a type of a menu item. The layout may change based on a type of an item corresponding to a menu item, and the layout may be changed based on the detailed information displayed on the touch display 110.

For example, when one item of the processor 120 is a calendar item, if the touch area is less than the first threshold value, the processor 120 may display the daily content in a first layout corresponding to the first depth, and if the touch area is greater than or equal to the first threshold value and less than the second threshold value, display the weekly content with a second layout corresponding to the second depth, and if the touch area is greater than or equal to the second threshold value, control the touch display to display the monthly content with the third layout corresponding to the third depth.

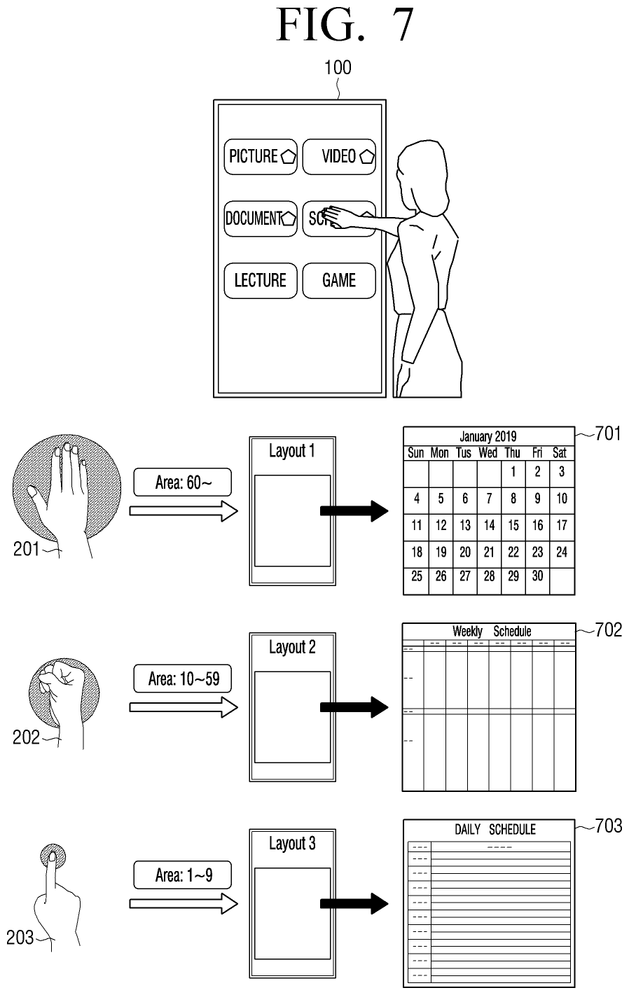

The processor 120 may identify a depth of the touch input based on the touch area, determine a layout (daily, weekly, and monthly) corresponding to a range of detailed information corresponding to the identified depth or a layout corresponding to the identified depth, obtain the detailed information (daily schedule information, weekly schedule information, and monthly schedule information) of the determined range of the detailed information or determined layout (daily layout, weekly layout, and monthly layout), and control the touch display 110 to display the obtained detailed information with each layout or display each detailed information (or content) with the obtained layout. Specific description will be given in FIG. 7.

When one item is a content list item, the processor 120 can display a text list for a plurality of content with a first layout corresponding to the first depth if the touch area is less than the first threshold value, and can display the thumbnail and title information of the plurality of content with the second layout corresponding to the second depth if the touch area is greater than or equal to the first threshold value and is less than the second threshold value, and can control the touch display 110 to display an image of the plurality of content with the third layout corresponding to the third depth if the touch area is greater than or equal to the second threshold value.

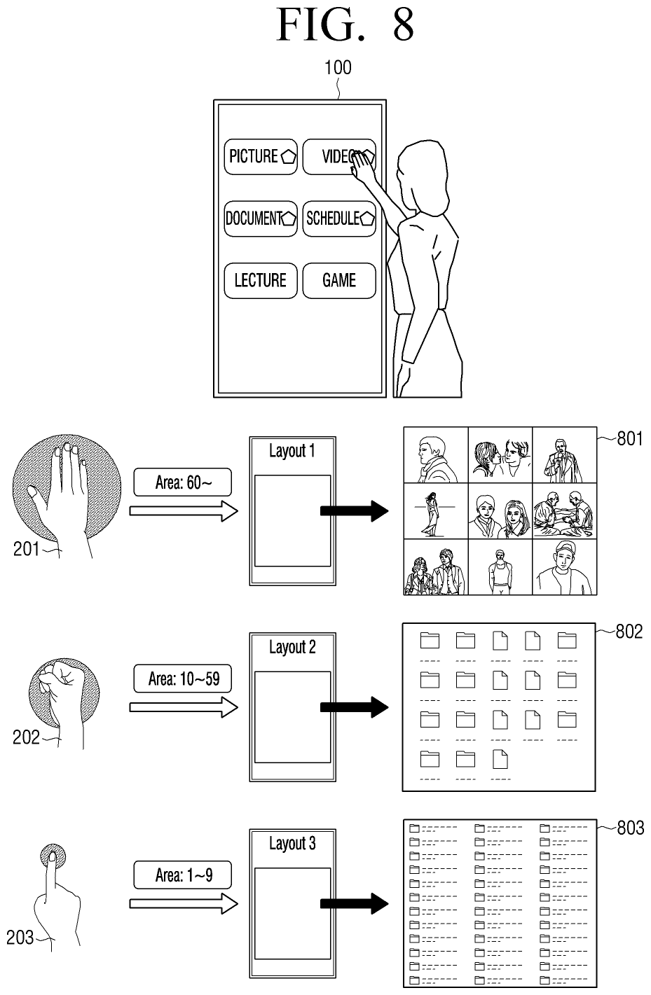

The detailed description will be described below with reference to FIG. 8. Here, the text list may include information of at least one of a file name of the content, a file type, a file location, or a file size. In addition, the thumbnail may refer to a representative image that is set to be easy to see while content is being searched. The title information may refer to the name of the file. The image of the content may be a reduced size image if the content is an image. According to an embodiment, the image of the content may be the same as or different from the thumbnail.

The processor 120 may identify the depth of the touch input based on the touch area, determine a layout to display detailed information corresponding to the identified depth (text list, thumbnail and title, content image), obtain detailed information (text list information, thumbnail and title information, content image information), and control the touch display 110 to display the obtained detailed information in the determined layout. The detailed description will be described below with reference to FIG. 7.

As another example, if one item is a content list item, the processor 120 may control the touch display to display the content file list in a first layout corresponding to the first depth if the touch area is less than the first threshold value, and may display the lower folder list in a second layout corresponding to the second depth if the touch area is greater than or equal to the first threshold value and less than the second threshold value, and display the upper folder list in a third layout corresponding to the third depth if the touch area is greater than or equal to the second threshold value.

The processor 120, when a user input to click a menu item is received, may identify a touch area of a user input, determine a depth corresponding to the identified touch area, identify a layout corresponding to the detailed information (upper folder, lower folder, content) pre-mapped to the determined depth, obtain detailed information (upper folder list, lower folder list, and content list) corresponding to the identified layout, and control the touch display 110 to display the obtained detailed information in the identified layout. Here, the upper folder list, the lower folder list, and the content list may refer to all items corresponding to a specific depth (specific layer). For example, when a user input of touching a menu item is received, the processor 120 may determine a depth (upper layer folder, middle layer folder, lower layer folder, content) according to the touch area, and obtain all the folder lists or all content list of the corresponding depth or layer.

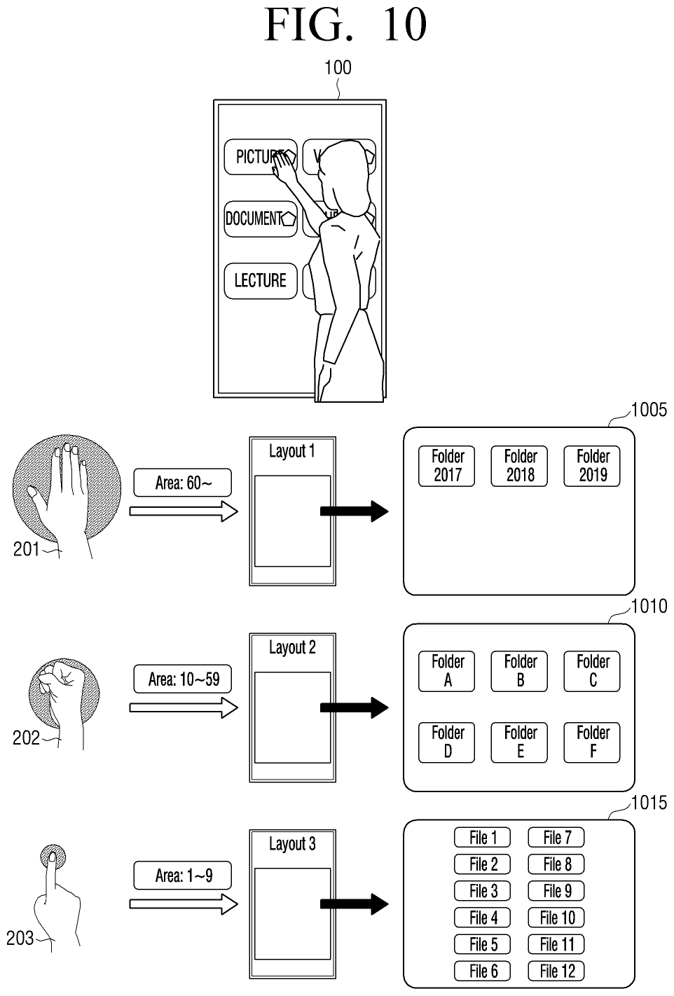

The upper folder may be substituted with a top folder according to an embodiment, and the lower folder may be substituted with a bottom folder. A specific description will be given in FIG. 10.

The processor 120 may control the touch display 110 to display fewer number of contents as the size of the touch area increases.

When the size of the touch area is large, the processor 120 may provide a layout that displays detailed information for the displayed content (or folder) to be large. In addition, when the size of the touch area is small, the processor 120 may provide a layout for displaying the detailed information about the displayed content (or folder) to be small. For example, if the touch area is 100, the processor 120 may display six contents (or folders), and if the area is 50, the processor 120 may display 12 contents (or folders), and if the area is 25, the processor 120 may display 24 contents (or folders).

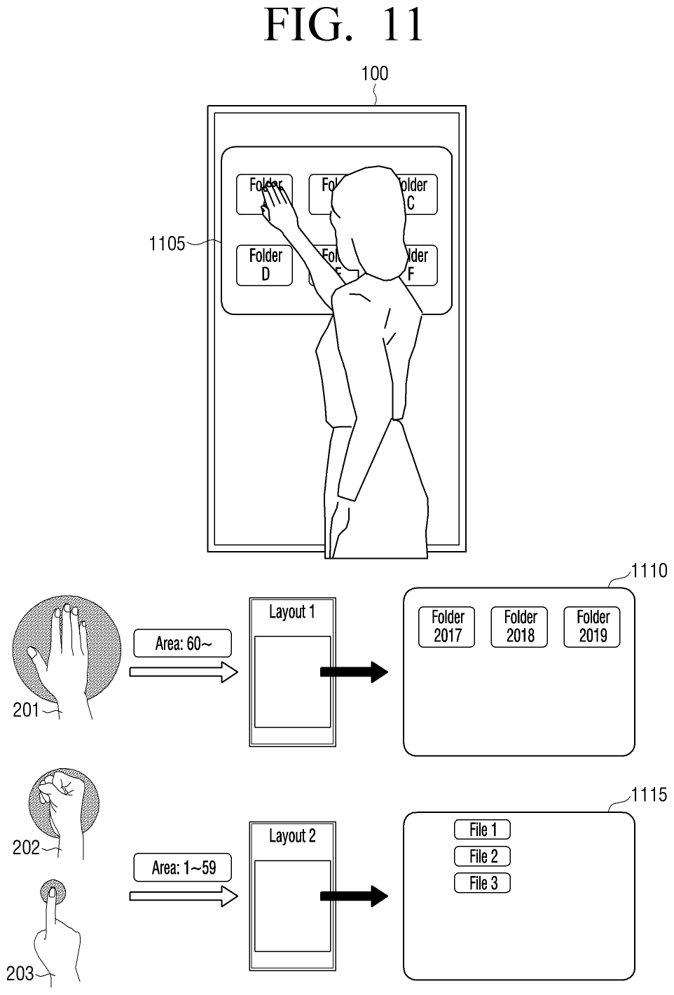

Meanwhile, the touch input of the user is a first touch input, the processor 120 may display a UI for changing a layout corresponding to the identified information depth, and when a second touch input of the user is received on the UI, the touch area corresponding to the second touch input may be identified and the layout may be changed based on the touch area corresponding to the second touch input. Here, the operation of changing the depth of the detailed information may mean moving from the lower layer to the upper layer. For example, it is assumed that a first layer (upper layer folder), a second layer (middle layer folder), a third layer (lower layer folder), and a fourth layer (content) are structured. The processor 120 may divide the depth of detailed information into a first layer, a second layer, a third layer, and a fourth layer, and may perform a control operation to move the depth corresponding to the touch area. For example, when the user touches the UI corresponding to the second layer, a folder list corresponding to the first layer may be displayed according to the touch area, or a folder list corresponding to the third layer may be displayed. Here, the processor 120 does not display all folder lists and may control the touch display 110 such that only a structured folder list is displayed. A detailed description of the structurization will be described below with reference to FIG. 11.

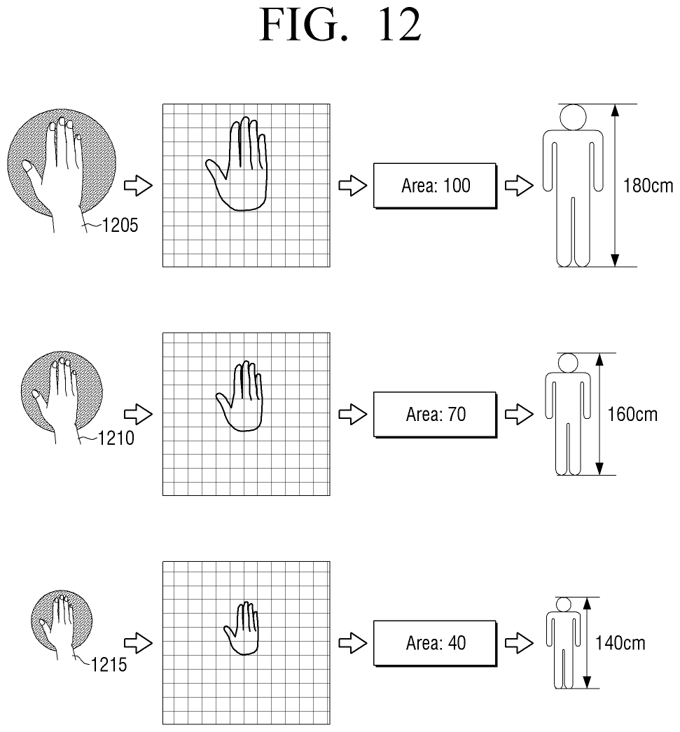

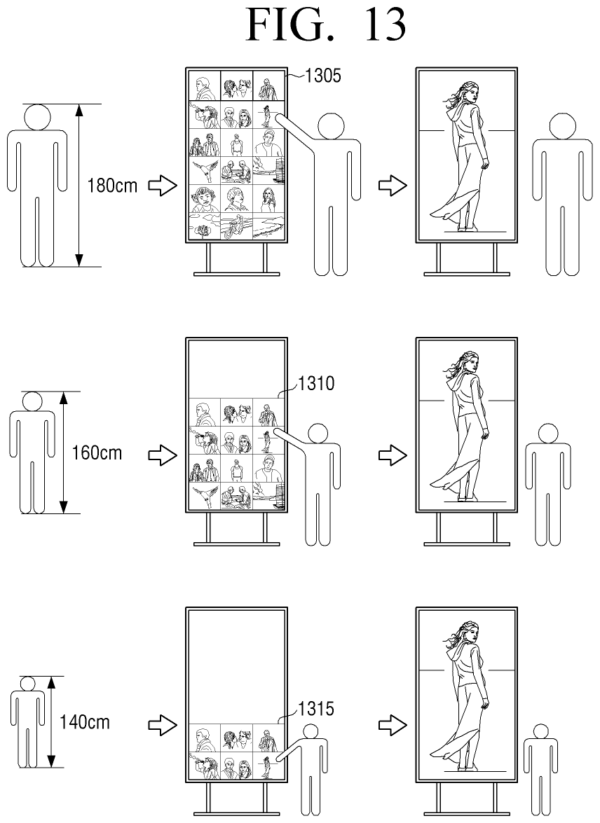

The processor 120 may identify the user's body size based on the identified touch area if the touch shape corresponding to the touch input is a palm shape, identify a location of the display on which the content is to be displayed based on the body size, and control the touch display 110 to display the content in a layout corresponding to the identified information depth on the identified display. A detailed description will be described below with reference to FIGS. 12 and 13. Here, the body size may mean a height of a user. According to another example, the body size may be identified in a shape of a fist or a finger that is not a palm.

When the user's touch input is a first touch input, and the user's second touch input is received, the processor 120 may identify the left and right information of the hand corresponding to the second touch input and the touch area corresponding to the second touch input, identify a scroll direction based on left and right information of the hand, identify a scroll speed based on touch area corresponding to the second touch input, and change a displayed screen based on the identified scroll direction and the scroll speed.

For example, when the user input is the left hand, the processor 120 may determine to move the scroll upwards (to display the previous page of the current page) and control the scroll speed according to the touch area. Here, in the case of the palm touch, the scroll movement speed may be faster than in the case of the finger touch. Conversely, when the user input is the right hand, the processor 120 may determine to move the scroll downward (to display the next page of the current page) and control the scroll speed according to the touch area.

The display apparatus 100 according to an embodiment may provide different layouts in consideration of a touch area of a user input. Therefore, the user does not need to touch a specific UI for a separate setting command, and the display apparatus 100 may quickly perform a control operation corresponding to the user's intention.

According to another embodiment, the display apparatus 100 may provide different layouts considering a touch shape and a touch area of the user input at the same time. Therefore, each control operation corresponding to the touch shape and the touch area may be performed.

An operation to display a content with a layout corresponding to information depth may be replaced with an operation to display detailed information corresponding to the identified depth to a layout corresponding to the identified depth.

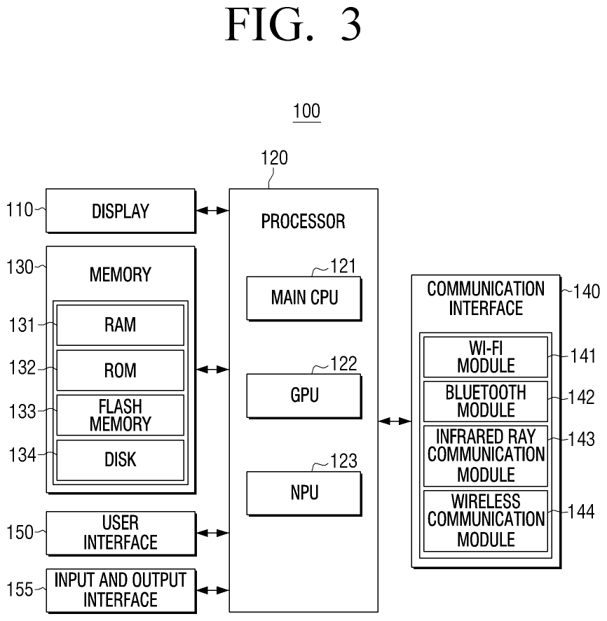

FIG. 3 is a block diagram illustrating a detailed configuration of a display apparatus of FIG. 2.

Referring to FIG. 3, the display apparatus 100 according to an embodiment may include the display 110, the processor 120, the memory 130, the communication interface 140, a user interface 150, and an input and output interface 155.

The operations of the display 110 and the processor 120 which have been described above will not be described.

The memory 130 may mean a storage device that is implemented in various types such as a random access memory (RAM) 131, read-only memory (ROM) 132, flash memory 133, and a disk 134. The memory 130 may mean a memory device or storage device that temporarily or permanently preserve data. The memory 130 may store various software such as an application or operating system (O/S) of the display apparatus 100. The memory 130 may be implemented as dynamic RAM (DRAM), static RAM (SRAM), synchronous dynamic RAM (SDRAM), ferroelectric random Access memory (FeRAM), one time programmable ROM (OTPROM), programmable ROM (PROM), erasable and programmable ROM (EPROM), electrically erasable and programmable ROM (EEPROM), mask ROM, flash ROM, flash memory 133, NAND flash, NOR flash, floppy disk, hard disk drive (HDD), optical disk drive, solid-state drive or solid state disk (SDD), compact flash (CF), secure digital (SD), micro secure digital (micro-SD), mini secure digital (mini-SD), extreme digital (xD), multi-media card (MMC), universal serial bus (USB) memory, and a memory card type.

The memory 130 may be divided into a volatile memory and a non-volatile memory according to volatility.

The embodiment of the memory 130 has been disclosed in the above description, but the embodiment is not limited thereto.

The communication interface 140 is a configuration to communicate with various types of external devices according to various types of communication methods. The communication interface 140 includes a Wi-Fi chip 141, a Bluetooth chip 142, an infrared ray communication chip 143, a wireless communication module 144, or the like. The processor 120 may communicate with various external devices using the communication interface 140. Here, the external device may include an electronic device such as a TV, an image processing device such as a set-top box, an external server, a control device such as a remote control, an audio output device such as a Bluetooth speaker, a lighting device, a smart cleaner, a home appliance such as a smart refrigerator, a server such as an Internet of things (IOT) home manager, or the like. The communication interface 140 may include a circuitry to execute the above operation.

The Wi-Fi module 141 and the Bluetooth module 142 perform communication by the Wi-Fi method and Bluetooth method, respectively. When using the Wi-Fi module 141 or the Bluetooth module 142, the various connection information such as the SSID and the session key may be transceived first, and various information may be transceived after communication connection.

The infrared ray communication module 143 performs communication according to infrared data association (IrDA) technology that transmits data wireless to local area using infrared ray between visible rays and millimeter waves.

The wireless communication module 144 means a module performing communication according to various communication standards such as Zigbee, 3^{rd} generation (3G), 3^{rd} generation partnership project (3GPP), long term evolution (LTE), LTE advanced (LTE-A), 4^{th} generation (4G), 5^{th} generation (5G), or the like, in addition to the Wi-Fi module 141 and the Bluetooth module 142 described above.

The communication interface 140 may include at least one of a local area network (LAN) module, Ethernet module, or wired communication module performing communication using a pair cable, a coaxial cable, an optical cable, or the like.

According to an embodiment, the communication interface 140 may use the same communication module (for example, Wi-Fi module) to communicate with an external device such as a remote controller and an external server.

In accordance with another example, the communication interface 140 may utilize different communication modules (for example, Wi-Fi modules) to communicate with an external device such as a remote controller and an external server. For example, the communication interface 140 may use at least one of an Ethernet module or a Wi-Fi module to communicate with an external server, and may use a bluetooth (BT) module to communicate with an external device such as a remote controller. However, this is merely exemplary, and the communication interface 140 may use at least one communication module among various communication modules when communicating with a plurality of external devices or an external server.

The communication interface 140 may additionally include a tuner and a demodulator according to examples.

The tuner (not shown) may receive a radio frequency (RF) broadcasting signal by tuning a channel selected by a user or all the prestored channels, from among RF broadcasting signals that are received through the antenna.

A demodulator (not shown) may receive and demodulate a digital intermediate frequency (DIF) signal that is converted by the tuner, and perform channel decoding, or the like.

The processor 120 controls overall operations of the display apparatus 100) using various programs stored in the memory 130. The processor 140 may be implemented with at least one of a main central processing unit (CPU) 121, a graphics processing unit (GPU) 122 or a neural processing unit (NPU) 123. At least one of the main CPU 121, GPU 122, or NPU 123 may be connected to each other with RAM 131 or ROM 132, or the like, corresponding to the memory 130.

The main CPU 121 may control the O/S of the display apparatus 100 using a command set, or the like, for booting a system stored in the ROM 132. When the turn-on command is input and power is supplied, the CPU 121 copies the OS stored in the memory 130 to the RAM 131 according to a command stored in the ROM 132, and executes the OS to boot the system. When the booting is completed, the CPU 121 copies various application programs stored in the memory 130 to the RAM 131, may execute the application program copied to the RAM 131, and perform various operations.

The main CPU 121 accesses the memory 130 and performs booting using an operating system (OS) stored in the memory 130, and may perform various operations using various programs, contents data, or the like, stored in the memory 130.

The GPU 122 may be a high-performance processing device for graphics processing, and may be a specialized electronic circuit that is designed to rapidly process a memory and accelerate generation of an image in a frame buffer to be output to a screen. The GPU 122 may mean a visual processing unit (VPU).

The NPU 123 may correspond to an AT chipset (or AI processor) or an AI accelerator. The NPU 123 may be a processor chip optimized for performing deep neural network. The NPU 123 may be a processing device for executing a deep learning model instead of the GPU 122, and the NPU 123 may be a processing device for executing a deep learning model with the GPU 122.

In FIG. 3, the main CPU 121, GPU 122, and NPU 123 are displayed, but in actual implementation, the processor 120 may be implemented as at least one of the main CPU 121, GPU 122, or NPU 123.

The processor 120 may perform a graphic processing function (video processing function). For example, the processor 120 may generate a screen including various objects such as icons, images, text, and the like. Here, a calculator (not shown) may calculate an attribute value such as a coordinate value, a shape, a size, and a color to be displayed by each object according to the layout of the screen based on the received control command. A renderer (not shown) may generate display screens of various layouts including objects based on the attribute value calculated by the calculator (not shown). The processor 120 may perform various image processing such as decoding, scaling, noise filtering, frame rate conversion, resolution conversion, or the like, for the video data.

The processor 120 may perform processing of audio data Specifically, the processor 120 may perform various image processing such as decoding, amplifying, noise filtering, and the like, on the audio data.

The user interface 150 may be implemented as a button, a touch pad, a mouse, and a keyboard, or may be implemented as a touch screen which may perform the display function and a manipulation input function as well. Here, the button may be various types of buttons such as a mechanical button, a touch pad, a wheel, or the like formed on an arbitrary region such as a front portion, a side portion, a back portion, or the like, of an outer part of the main body of the display apparatus 100.

The input and output interface 155 may be one of the high-definition multimedia interface (HDMI), mobile high-definition link (MHL), universal serial bus (USB), display port (DP), Thunderbolt, video graphics array (VGA) port, RGB port, d-subminiature (D-SUB), digital visual interface (DVI), and the like.

The HDMI is an interface capable of transmitting high performance data for an AV device which inputs and outputs audio and video signals. The DP is the interface which may implement an image of a full HD but also an ultra-high resolution screen such as 2560X1600 or 3840X2160, and a 3D stereoscopic image, and transmit a digital sound. The Thunderbolt is an input/output interface for high-speed data transmission and connection, and may connect a PC, a display, a storage device, and the like, with one port in parallel.

The input and output interface 155 may input and output at least one of an audio signal and a video signal.

According to an example, the input and output interface 155 may include a port to input and output only an audio signal or a port to input and output only a video signal as a separate port, or may be implemented as a port which input and output both the audio signal and the video signal.

The display apparatus 100 may transmit the audio (or voice) signal to the external server in order to recognize audio (or voice) signal received from the external device.

In this case, a communication module for communicating with the external device and the external server may be implemented as one. For example, a communication module for communicating with the external device and the external server may be the same as the Wi-Fi module.

A communication module for communicating with the external device and the external server may be implemented separately. For example, communication with the external device may be performed through a Bluetooth module, and communication with the external server may be performed through the Ethernet modem or the Wi-Fi module.

A microphone (not shown) may receive the user voice in an active state. For example, the microphone (not shown) may be integrally formed as an integral unit on an upper side, a front side direction, a side direction, or the like of the display apparatus 100. The microphone (not shown) may include various configurations such as a microphone for collecting user voice in an analog format, an amplifier circuit for amplifying the collected user voice, an audio-to-digital (A/D) conversion circuit for sampling the amplified user voice to convert into a digital signal, a filter circuitry for removing a noise element from the converted digital signal, or the like.

The display apparatus 100 may further include a microphone (not shown). The microphone (not shown) is configured to receive user voice or other sound to convert to audio data. In this case, the microphone (not shown) may convert the received analog user voice signal to the digital voice signal and transmit the signal to the display apparatus 100.

The display apparatus 100 may transmit a received digital voice signal to a voice recognition server. In this case, the speech recognition server may convert the digital audio signal into text information using the STT. In this case, the speech recognition server may transmit text information to another server or an electronic apparatus to perform a search corresponding to the text information, and in some cases, perform a direct search.

The display apparatus 100 according to another embodiment may convert to text information by directly applying the STT function to the digital sound signal, and transmit the converted text information to the external server.

A speaker (not shown) may be an element to output various audio data, various alarm sounds, a voice message, or the like, which are processed by the input and output interface 150.

The display apparatus 100 does not necessarily include all the components of FIG. 3, and may include some components according to an embodiment.

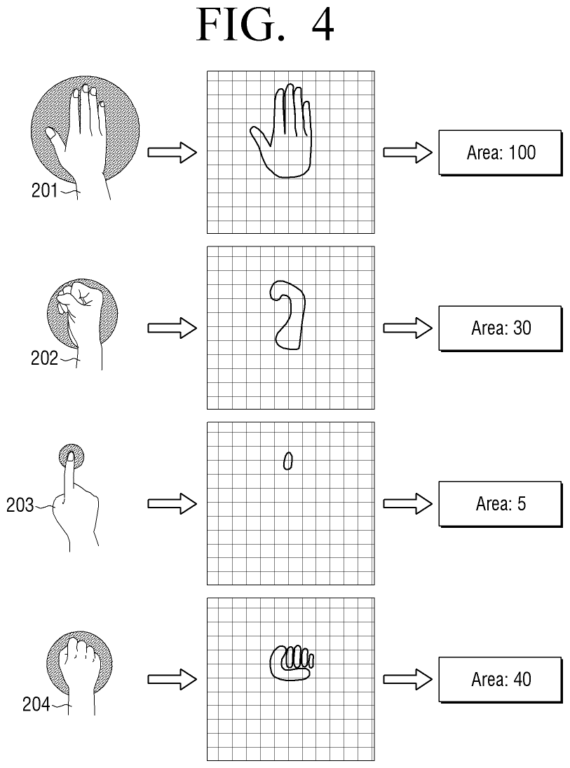

FIG. 4 is a view to describe an operation of a display apparatus to identify a touch area.

Referring to FIG. 4, the display apparatus 100 may receive a user's touch input and identify a touch area corresponding to the received touch input. The display apparatus 100 may receive a touch input of a user using the touch display 110. The user's touch input may be various, including the palm touch 201, first fist touch 202, finger touch 203, second fist touch 204, or the like.

The palm touch 201 may mean that both the palm and the finger are in contact with the touch surface. Here, the touch surface may mean a contact surface on which a user's skin is touched on the touch display 110. The first fist touch 202 may mean a state in which an outer portion of the little finger is in contact with the touch surface, while the fist is clenched, and may mean that the skin around Triquetrum. Pisiform bone or pisiforme, Lunate bone is in contact with the touch surface. The finger touch 203 may mean touching the touch surface with a finger or touching the touch surface by the skin around the distal phalanges of hand. The second fist touch 204 may mean that the skin around the metacarpal bones of the thumb and around the middle phalanges of hand of the rest of the fingers (index finger to the ring finger) is in contact with the touch surface. In FIG. 4, various touch inputs 201-204 are described, but these are merely exemplary, and the display apparatus 100 can receive various touch inputs.

The display apparatus 100 may receive various touch inputs and calculate (or identify) a touch area corresponding to the touch input. The display apparatus 100 can digitize the calculated touch area and store the same in the memory of the display apparatus 100. Specifically, the display apparatus 100 can receive a touch location for a user's touch input when a user's touch input is received. The display apparatus 100 may analyze the received touch location and obtain a touch area based on the touch location on the touch display 110. The display apparatus 100 may calculate an area of a touched location on the touch display 110 to obtain a touch area corresponding to the touch input.

If the palm touch 201, the first fist touch 202, the finger touch 203, and the second fist touch 204 are input to the touch display 110, respectively, the display apparatus 100 may obtain a touch area in consideration of the touch location input to the touch display 110. In the case of palm touch 201, the largest touch area may be identified because the largest part is in contact with the touch surface. The first fist touch 202 or the second fist touch 204 may be identified as an intermediate level of touch area. In addition, the finger touch 203 may be identified as having the least portion that is in contact with the touch surface.

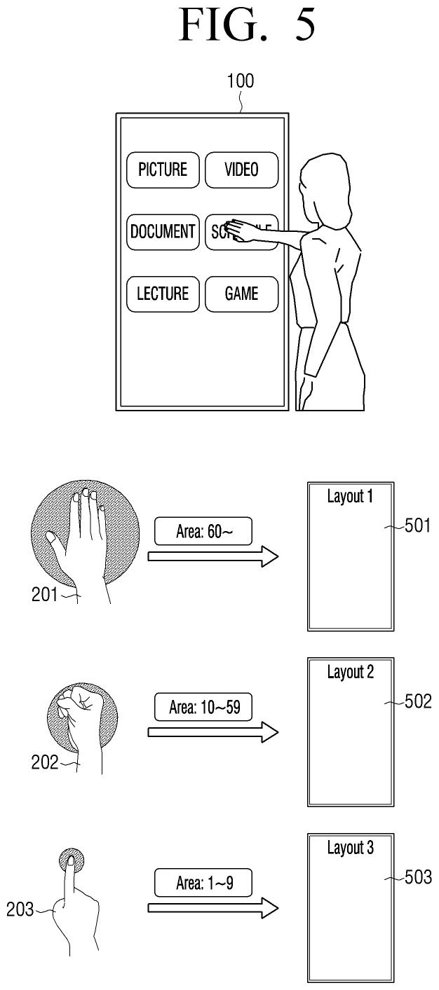

FIG. 5 is a view to describe an operation of a display apparatus for providing a layout corresponding to a touch area.

Referring to FIG. 5, the display apparatus 100 may provide a screen for displaying a plurality of menu items on the touch display 110. The plurality of menu items may include a picture item UI, a video item UI, a document item UI, a schedule item UI, a lecture item UI, and a game item UI. When the user of the display apparatus 100 touches a specific menu item, the display apparatus 100 may provide different layouts in consideration of a touch area.

If the display apparatus 100 receives the palm touch 201, the display apparatus 100 may identify the touch area of the touch input. In addition, a different layout may be provided corresponding to the identified touch area. For example, the display apparatus 100 may divide the touch area into a predetermined range in consideration of a touch area corresponding to a user input, and the display apparatus 100 may provide a different layout to correspond to a touch area based on whether the touch area belongs to a divided range.

The display apparatus 100 may divide a touch area into a predetermined section. For example, if the touch area is greater than or equal to 60, the display apparatus 100 may provide the first layout 501, the display apparatus 100 may provide the second layout 502 when the touch area is 10 to 59, and the display apparatus 100 may provide the third layout 503 when the touch area is 1-9. The number described in FIG. 5 may be a value for a particular unit and may be a relative value displayed after the touch area is identified. In addition, the display apparatus 100 may change the number of sections according to a user's setting or a preset method.

FIG. 6 is a view to describe a guide UI for guiding provision of a layout in consideration of a touch area.

Referring to FIG. 6, the display apparatus 100 may distinguish an item for differently applying a layout according to a touch area. The display apparatus 100 may display a guide UI 610 in a menu item that differently displays a layout according to a touch area. In addition, a separate UI may not be displayed in the menu item that does not display the layout differently according to the touch area. The menu item may be a UI for classifying a specific content or program according to a subject. For example, it is assumed that there are menu items such as a picture, a video, a document, a schedule, a lecture, a game, or the like.

In this case, the display apparatus 100 may set the layout differently in consideration of the touch area only for the menu items of the picture, video, document, and schedule. The display apparatus 100 may display the guide UI 610 only in the menu items of the picture, video, document, and schedule. The user may easily recognize that the menu item displayed with the guide UI may display a different layout according to the touch area.

FIG. 7 is a view to describe an embodiment of providing a schedule layout in consideration of a touch area.

Referring to FIG. 7, it is assumed that the user touches a schedule layout among a plurality of menu items. The display apparatus 100 may identify a touch area corresponding to a user's touch input, and provide a schedule layout corresponding to a touch area.

For example, when the touch area is greater than or equal to 60, the display apparatus 100 may provide a monthly schedule layout 701. When the touch area is 10 to 59, the display apparatus 100 may provide a weekly schedule layout 702. When the touch area is 1-9, the display apparatus 100 may provide a daily schedule layout 703.

FIG. 8 is a view to describe an embodiment of providing a layout for a content list according to a touch area.

Referring to FIG. 8, it is assumed that the user touches a video menu item among a plurality of menu items. The display apparatus 100 may identify a touch area corresponding to the user's touch input, and provide a video file list layout corresponding to a touch area.

For example, if the touch area is greater than or equal to 60, the display apparatus 100 may provide a layout 801 including only a first thumbnail image. If the touch area is 10 to 59, the display apparatus 100 may provide a layout 802 including the second thumbnail image and the file name. If the touch area is 1 to 9, the display apparatus 100 may provide the layout 803 including the file name and the file location. Here, the first thumbnail image and the second thumbnail image may be the same or different according to the user's setting. In addition, the range of detailed information displayed in each layout (the first thumbnail image, the second thumbnail image, the file name, the file location) may be changed according to the user's setting. In one example, only the file name may be displayed in the layout 803.

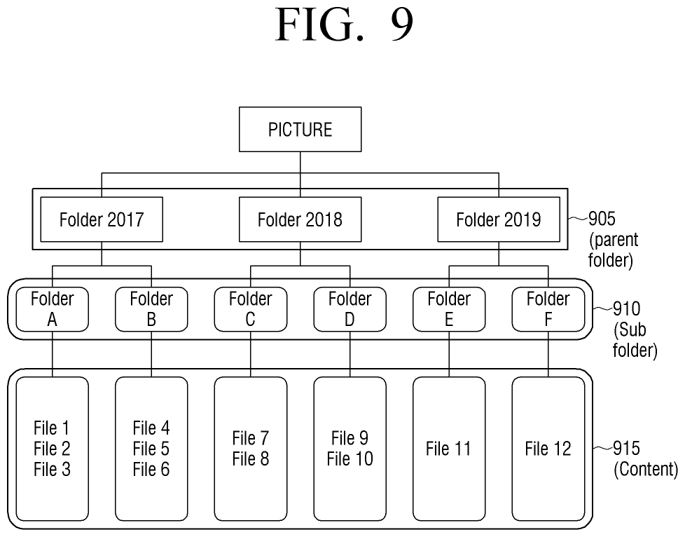

FIG. 9 is a view to describe a structured relation of a content list according to an embodiment.

Referring to FIG. 9, files may be stored in a hierarchical folder in the memory 130 of the display apparatus 100. The folder named Picture may include folders named folder 2017, folder 2018, and folder 2019. Folder 2017, folder 2018, and folder 2019 may correspond to an upper folder (parent folder) 905. Folder 2017 may include folder A and folder B, folder 2018 may include folder C and folder D, and folder 2019 may include folder E and folder F. Here, folder A, folder B, folder C, folder D, folder E, and folder F may correspond to subfolders (subfolders) 910. Files1, 2, and 3 are stored in folder A, files 4, 5, and 6 are stored in folder B, files 7 and 8 are stored in folder C, files 9 and 10 are stored in folder D, file 11 may be stored in folder E, and file 12 may be stored in folder F. Here, file 1 to file 12 may correspond to a content 915.

FIG. 10 is a view to describe an embodiment of providing a layout for a content list in consideration of a touch area in a structured relation of FIG. 9.

Referring to FIG. 10, it is assumed that the user touches a picture menu item of FIG. 9. The display apparatus 100 may display all the files or folders belonging to a specific layer in consideration of a user's touch area.

For example, when the touch area is greater than or equal to 60, the display apparatus 100 may provide a layout 1005 in which all the upper folders (parent folders) lists are displayed. When the touch area is 10 to 59, the display apparatus 100 may provide the layout 1010 in which all the lower folder lists are displayed. When the touch area is 1 to 9, the display apparatus 100 may provide a layout 1015 including all the content list.

The display apparatus 100 may provide a layout that meets the user's intention by displaying all the file lists or folder lists included in a specific layer in consideration of the touch area of the layered files or folders belonging to a menu item.

In FIG. 10, it has been described an embodiment in which the user touches a menu item.

FIG. 11 is a view to describe a still another embodiment of providing a layout for a content list in consideration of a touch area in a structured relation of FIG. 9.

Here, meaning of the structured relation or structurization may mean that an upper folder and a lower folder may be related to each other. Referring to FIG. 11, when a user's input is received in a specific layout 1105, the display apparatus 100 may provide a layout 1110 including a folder list of an upper layer or a layout 1115 including a content list of a lower layer. Here, the detailed information folder A included in the layout 1105 may correspond to structured relation (structurized relation) with files 1 to 3.

Referring to FIG. 11, it is assumed that the user touches the lower folder A. Here, the display apparatus 100 may display a list of contents included in a lower folder or an upper folder list of a lower folder according to a touch area. Specifically, if the touch area is greater than or equal to 60, the display apparatus 100 may display the upper folder list (folder 2017, folder 2018, and folder 2019) of the lower folder (folder A). In addition, when the touch area is 1 to 59, the display apparatus 100 may display a content list (files 1, 2, 3) included in a lower folder (folder A).

When the menu item is touched, the display apparatus 100 may display all the files or folders included in a layer according to a touch area, and when a specific lower folder is touched, the display apparatus 100 may display a content included by an upper folder related to a touched lower folder or a touched lower folder.

FIG. 12 is a view to describe an embodiment of identifying body information of a user in consideration of a touch area and a touch shape corresponding to a touch input.

Referring to FIG. 12, the display apparatus 100 may analyze a user's touch input to identify a touch area and a touch shape. As an example, the display apparatus 100 may identify whether a user's touch is made by a palm, a fist, a finger, or a touch pen. The display apparatus 100 can identify the user's body information based on the touch area and the touch shape when it is determined that the user's body is in direct contact. The body information may refer to user-specific characteristic information, such as a user's height, fingerprint, handicap in a hand, or the like.

When the user's touch is a palm, the display apparatus 100 may identify the height of the user in consideration of the size of the palm. Based on the predetermined data, a height corresponding to the touch area of the palm may be determined. In order to determine a height corresponding to the touch space, a prestored comparison table or an artificial intelligence (AI) learning model may be used.

When the user's input 1205 is received, the display apparatus 100 may obtain the touch area 100 and assume that the user's height is 180 cm according to the touch area 100. Further, when the user's input 1210 is received, the display apparatus 100 may obtain the touch area 70, and assume that the user's height is 160 cm according to the touch area 100. Further, when the user's input 1215 is received, the display apparatus 100 may obtain the touch area 40, and assumed that the user's height is 140 cm according to the touch area 100.

FIG. 13 is a view to describe an embodiment of providing a layout differently based on user's body information.

Referring to FIG. 13, the display apparatus 100 may provide different layouts in consideration of the identified user's body information. In general, when a plurality of contents are not displayed on one screen in a screen on which a plurality of contents (or folders) are displayed, the user should move the screen by manipulating a scroll UI or directly touching the display. For example, if only 20 out of 100 contents are displayed on a screen, the user should move the screen to view the remaining contents list. In this case, there is a problem in that it is difficult for the user to click on a content list displayed at a position higher than the user's height (exactly, the highest height in a range of reaching hand by the user). For a portion to which the user may not reach with the user's height, a content may be touched by moving the screen. However, there is a problem in that the screen is no longer moved for the content displayed in the uppermost area and the user may not select. To solve this problem, the display apparatus 100 may provide a layout corresponding to the user's height by clicking on the user's body.

For example, when the user's height is determined to be 180 cm, the display apparatus 100 may determine that all the areas of the display 110 may be touched, and the display apparatus 100 may provide a layout 1305 displaying a content using all the areas on a display screen.

When it is determined that the height of the user is 160 cm, the display apparatus 100 may determine that a partial area of the display 110 may be touched, and the display apparatus 100 may provide a layout 1310 using a partial area of the display screen. Here, the layout 1310 using a partial area may refer to a layout not displaying a specific UI in an area where a user of 160 cm may not touch.

In addition, if it is determined that the user's height is 140 cm, the display apparatus 100 may determine that partial area of the display 110 may be touched, and the display apparatus 100 may provide a layout 1315 that uses a partial area of the display screen. Here, the layout 1315 using a partial area may mean a layout in which a specific UI is displayed only in an area which the user of 140 cm may touch.

If a specific item is displayed, the display apparatus 100 may display a specific item list using a partial area according to the user's height.

According to another embodiment, an operation of using only a partial region of the display apparatus 100 may be performed only when a content list corresponding to a top area of the plurality of content lists is displayed. For example, the display apparatus 100 may display a content list displayed in the uppermost area in a layout using only a partial area, and display a content list not displayed in the uppermost area in a layout using the entire area. Here, the content list corresponding to the uppermost area may mean content displayed on the first screen among the plurality of contents. The layout of the content displayed on the first screen may vary depending on the touch area.

When actually displaying an item among a particular item list, the entire display 110 area may be used. When detailed information on one item is displayed, the user's height may not be considered. The display apparatus 100 may reduce the inconvenience of a user by providing a layout suitable for a user's height.

FIG. 14 is a view to describe an operation of a display apparatus for identifying left and right hand information based on user's touch input.

Referring to FIG. 14, the display apparatus 100 may obtain left and right information of a user's hand according to a touch input. The display apparatus 100 may identify left and right information in consideration of a touch shape. Since the touch shape of the user depends on whether the user touches by the left hand or right hand, the display apparatus 100 may analyze a touch shape of the user input to obtain right and left information of the user's hand.

The user input may be divided into a right palm touch 201, a right hand first fist touch 202, a right hand second fist touch 204, a left hand palm touch 211, a left hand first fist touch 212, and a left hand second fist touch 214, and the display apparatus 100 may obtain left and right information of the user's hand according to a touch shape. Although the left and right information of the user's hand may be distinguished according to the analysis technique even in the case of a finger touch, a detailed description thereof will be omitted.

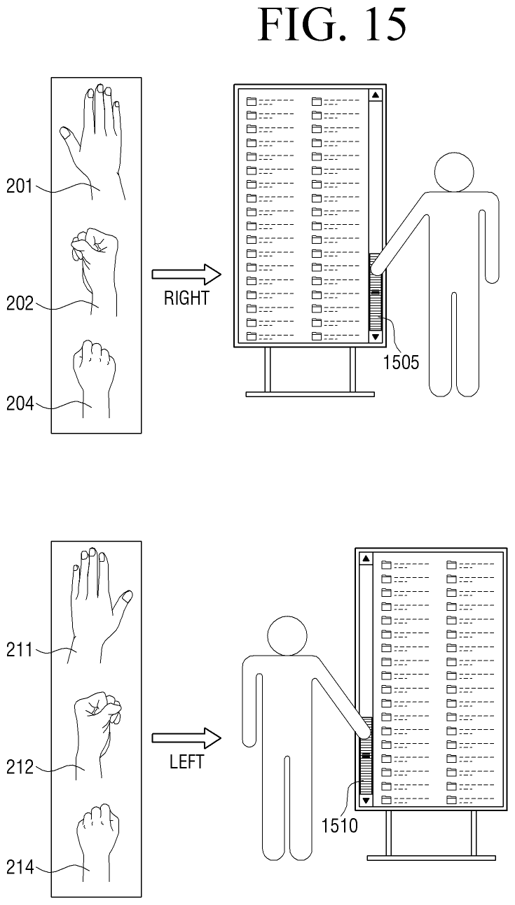

FIG. 15 is a view to describe an embodiment of providing a layout differently based on left and right hand information.

Referring to FIG. 15, the display apparatus 100 may provide different layouts (or UI) based on left and right hand information of the touch input.

For example, when it is identified that the user input is [right palm touch 201, right hand first fist touch 202, right hand second fist touch 204], the display apparatus 100 may provide a layout (or UI) for the right-handed user. To be specific, the display apparatus 100 may display a scroll bar (scroll UI) 1505 on a right side of the display.

When it is identified that the user input is the left touch [left hand palm touch 211, left hand first fist touch 212, left hand second fist touch 214], the display apparatus 100 may provide a layout (or UI) for a left-handed user. To be specific, the display apparatus 100 may display a scroll bar (scroll UI) 1510 on a left side of the display 110.

The display apparatus 100 may analyze a user's touch input and determine which hand a user mainly uses. Based on left and right hand information of the user, the display apparatus 100 may identify at which position the user is standing. When there are a lot of right-hand touches, the display apparatus 100 may determine that the user stands at the right side of the display apparatus 100. For the user who stands at the right side of the display apparatus 100, the scroll bar (scroll UI) may be displayed on the right side of the display 110. Conversely, when there are a lot of left-hand touches, the display apparatus 100 may determine that the user stands at a left side of the display apparatus 100. For the user who stands at the left side of the display apparatus 100, the display apparatus 100 may display the scroll bar (scroll UI) on the left side of the display 110.

The display apparatus 100 may analyze the left and right hand information of the user to identify a position of the user and improve user convenience by providing a layout (or UI) corresponding to the user's position.

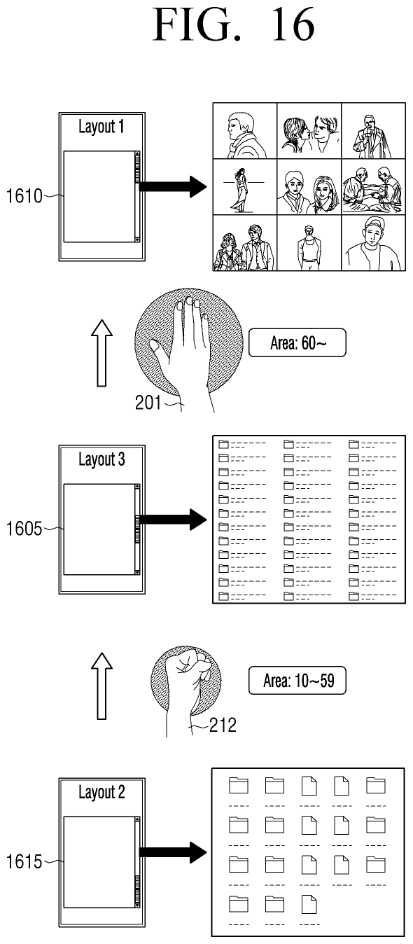

FIG. 16 is a view to describe a still another embodiment of providing a layout differently based on left and right hand information.

Referring to FIG. 16, the display apparatus 100 may provide different layouts in consideration of both of the left and right hand information of the user and the touch area. For example, the display apparatus 100 may determine a layout displayed on the touch area to control a position movement of the screen displayed based on the left and right hand information. When the right hand is touched, the display apparatus 100 may display an item (content) that is displayed at an uppermost part of the currently-displayed layout, and when the left hand is touched, the display apparatus 100 may display an item (content) that is displayed at a lowermost part of the currently-displayed layout.

It is assumed that the user touches a specific portion of a screen 1605 of layout 3 of FIG. 8. When the user inputs right hand palm touch 210 of the screen of layout 3, the display apparatus 100 may display an item (content) displayed at the uppermost part at the same time of providing layout 1 in which only a first thumbnail image is displayed, in consideration of a touch area. When the user inputs the left hand first fist touch 212 in the screen of layout 3, the display apparatus 100 may display an item (content) displayed at the lowermost part at the same time of providing layout 2 in which a second thumbnail image and a file name are displayed in consideration of a touch area.

FIG. 17 is a view to describe an embodiment of providing a layout differently according to a touch area of a touch input and a moving direction of two hands.

The display apparatus 100 may identify a touch input of the user by using two hands. For example, the user may contact a touch surface by palms, fists, and fingers of two hands at the same time. The display apparatus 100 may identify whether the user touches two hands based on a touch shape. When two hands are touched, different layouts may be provided. In another embodiment, the display apparatus 100 may not consider a touch area when touching by one hand, and may consider a touch area only when touching by two hands to provide layouts differently.

In a still another embodiment, the display apparatus 100 may identify an input 1710 to move both palms outward, an input 1715 to move both palms inward, an input 1720 to move both first fists outward, an input 1725 to move both first fists inwards, an input 130 to move both fingers outward, an input 1735 to move both fingers inward, an input 1740 to move both second fists outward, and an input 1745 to move both second fists outward.

The display apparatus 100 can perform a separate control operation on the basis of whether two hands have been touched, whether two hands are moved outward 1710, 1720, 1730, 1740, or whether two hands are moved inward 1715, 1725, 1735, 1745, and can provide different layouts according to a touch area by two hands. For example, if the user has moved two hands outwardly, the display apparatus 100 may provide a sub-folder of the touched menu item to the layout corresponding to the touch area. Also, when the user moves two hands inward, the display apparatus 100 can provide the upper folder of the touched menu item to the layout corresponding to the touch area.

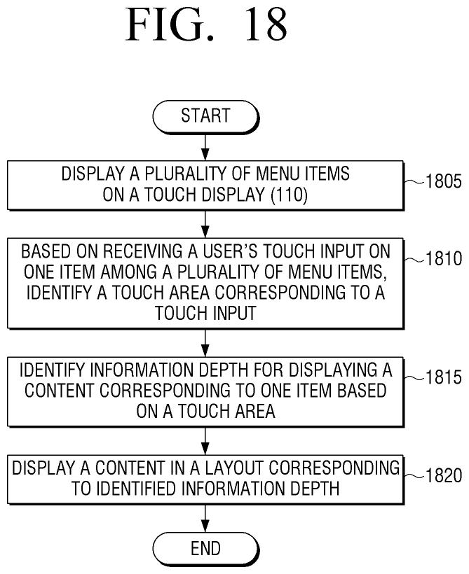

FIG. 18 is a flowchart to describe a controlling method of a display apparatus according to an embodiment.

In the controlling method of the display apparatus 100 according to an embodiment, a plurality of menu items may be displayed on the touch display 110 in operation S1805, a touch area corresponding to the touch input may be identified when a touch input of a user is received in one item among the plurality of menu items in operation S1810, and the information depth for displaying a content corresponding to one item may be identified based on the touch area in operation S1815, and the content may be displayed with a layout corresponding to the identified information depth in operation S1820.

If the touch area is less than the threshold value, the step S1820 may display content corresponding to one item in the first layout corresponding to the first depth, and if the touch area is greater than or equal to the threshold value, display the content corresponding to one item in the second layout corresponding to the second depth, and the number of content displayed in the second layout may be different from the number of content displayed in the first layout.

The controlling method may include displaying a guide user interface (UI) for guiding provision of a content in a different layout according to a touch area for an area in which the plurality of menu items are displayed.

The displaying the content in operation S1820 may include, based on the one item being a calendar item, in response to the touch area being less than a first threshold value, displaying a daily content in a first layout corresponding to a first depth, in response to the touch area being greater than or equal to the first threshold value and less than a second threshold value, displaying a weekly content in a second layout corresponding to a second depth, and in response to the touch area being greater than or equal to the second threshold value, displaying a monthly content in a third layout corresponding to a third depth.

The displaying the content in operation S1820 may include, based on the one item being a content list item, in response to the touch area being less than a first threshold value, displaying a text list for a plurality of contents in a first layout corresponding to a first depth, in response to the touch area being greater than or equal to the first threshold value and less than a second threshold value, displaying a thumbnail and title information of the plurality of contents, and in response to the touch area being greater than or equal to the second threshold value, displaying an image of the plurality of contents in a third layout corresponding to a third depth.

The displaying the content in operation S1820 may include, based on the one item being a content list item, in response to the touch area being less than a first threshold value, displaying a content file list in a first layout corresponding to a first depth, in response to the touch area being greater than or equal to the first threshold value and less than a second threshold value, displaying a lower folder list in the second layout corresponding to a second depth, and in response to the touch area being greater than or equal to the second threshold value, displaying an upper folder list in a third layout corresponding to a third depth.

The displaying the content in operation S1820 may include displaying a fewer number of content as a size of the touch area increases.

When the user's touch input is a first touch input, and the displaying the content in operation S1820 may include displaying a user interface to change a layout that corresponds to the identified information depth, and based on receiving a second touch input of the user on the user interface, identifying a touch area that corresponds to the second touch input and changing the layout based on a touch area that corresponds to the second touch input.

The controlling method may include, based on a touch shape that corresponds to the touch input being a palm shape, identifying a user's body size based on the identified touch area, identifying a position on a display on which the content is to be displayed based on the body size, and displaying the content in a layout corresponding to the identified information depth on the identified position on the display.

The controlling method may include, when a user's touch input is a first touch input, and the user's second touch input is received, based on receiving a second touch input of the user, identifying left and right hand information corresponding to the second touch input and a touch area corresponding to the second touch, identifying a scroll direction based on the left and right hand information, identifying a scroll speed based on a touch area corresponding to the second touch input, and changing a screen displayed based on the identified scroll direction and scroll speed.

The controlling method of the display apparatus 100 may be executed by the display apparatus 100 having the configurations of FIG. 2 or FIG. 3, or by the display apparatus 100 having other configurations.

The methods according to various embodiments as described above may be implemented as an application format which may be installed in a conventional display apparatus.

The methods according to various embodiments as described above may be implemented by software upgrade or hardware upgrade for the conventional display apparatus.

The various embodiments as described above may be performed through an embedded server provided in the display apparatus 100 or an external server of the display apparatus 100.

The controlling method of the display apparatus 100 according to an embodiment as described above may be implemented as a program and provided in the display apparatus 100. In particular, a program including the controlling method for the display apparatus 100 may be stored in a non-transitory computer readable medium and provided.

The various embodiments described above may be implemented in a recordable medium which is readable by computer or a device similar to computer using software, hardware, or the combination of software and hardware. By hardware implementation, the embodiments of the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. In some cases, embodiments described herein may be implemented by the processor 120 itself. According to a software implementation, embodiments such as the procedures and functions described herein may be implemented with separate software modules. Each of the above-described software modules may perform one or more of the functions and operations described herein.

Meanwhile, the computer instructions for performing the processing operations in the display apparatus according to the various embodiments described above may be stored in a non-transitory computer-readable medium. The computer instructions stored in this non-transitory computer-readable medium cause the above-described specific device to perform the processing operations in the display apparatus 100 according to the above-described various embodiments when executed by the processor of the specific device.

The non-transitory computer readable medium refers to a medium that stores data semi-permanently rather than storing data for a very short time, such as a register, a cache, a memory or etc., and is readable by an apparatus. In detail, the aforementioned various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

The foregoing embodiments and advantages are merely exemplary and are not to be construed as limiting the disclosure. The present teaching may be readily applied to other types of devices. Also, the description of the embodiments of the disclosure is intended to be illustrative, and not to limit the scope of the claims, and many alternatives, modifications, and variations will be apparent to those skilled in the art.

What is claimed is:

1. A display apparatus comprising:
a touch display; and
a processor configured to:
display a plurality of menu items on the touch display,
based on receiving a touch input to one item among the plurality of menu items, identify a touch area on the touch display corresponding to the touch input,
identify an information depth based on the identified touch area, and
perform control to display content corresponding to the one item in a layout corresponding to the identified information depth.

2. The display apparatus of claim 1, wherein the processor is configured to:
based on the touch area being less than a threshold value, perform control to display content corresponding to the one item in a first layout corresponding to a first depth, and,
based on the touch area being greater than or equal to the threshold value, perform control to display content corresponding to the one item in a second layout corresponding to a second depth,
wherein a number of the content displayed in the second layout is different from a number of the content displayed in the first layout.

3. The display apparatus of claim 1, wherein the processor is configured to control the touch display to display a guide user interface (UI) for guiding provision of content in a different layout according to a touch area for an area in which the plurality of menu items are displayed.

4. The display apparatus of claim 1, wherein the processor is configured to:
based on the one item being a calendar item, in response to the touch area being less than a first threshold value, perform control to display a daily content in a first layout corresponding to a first depth,
in response to the touch area being greater than or equal to the first threshold value and less than a second threshold value, perform control to display a weekly content in a second layout corresponding to a second depth, and,
in response to the touch area being greater than or equal to the second threshold value, perform control to display a monthly content in a third layout corresponding to a third depth.

5. The display apparatus of claim 1, wherein the processor is configured to:
based on the one item being a content list item, in response to the touch area being less than a first threshold value, perform control to display a text list for a plurality of contents in a first layout corresponding to a first depth,
in response to the touch area being greater than or equal to the first threshold value and less than a second threshold value, perform control to display a thumbnail and title information of the plurality of contents, and,
in response to the touch area being greater than or equal to the second threshold value, perform control to display an image of the plurality of contents in a third layout corresponding to a third depth.

6. The display apparatus of claim 1, wherein the processor is configured to:
based on the one item being a content list item, in response to the touch area being less than a first threshold value, perform control to display a content file list in a first layout corresponding to a first depth,
in response to the touch area being greater than or equal to the first threshold value and less than a second threshold value, perform control to display a lower folder list in the second layout corresponding to a second depth, and,
in response to the touch area being greater than or equal to the second threshold value, perform control to display an upper folder list in a third layout corresponding to a third depth.

7. The display apparatus of claim 1, wherein the processor is configured to perform control to display a fewer number of content as a size of the touch area increases.

8. The display apparatus of claim 1, wherein
the touch input is a first touch input, and
the processor is configured to:
display a user interface to change a layout that corresponds to the identified information depth, and
based on receiving a second touch input on the user interface, identify a touch area that corresponds to the second touch input and change the layout based on a touch area that corresponds to the second touch input.

9. The display apparatus of claim 1, wherein the processor is configured to:
based on a touch shape that corresponds to the touch input being a palm shape,
identify a user's body size based on the identified touch area,
identify a position on a display on which the content is to be displayed based on the identified body size, and
perform control to display the content in a layout corresponding to the identified information depth on the identified position on the display.

10. The display apparatus of claim 1, wherein
a touch input is a first touch input, and
the processor is configured to:
based on receiving a second touch input, identify left and right hand information corresponding to the second touch input and a touch area corresponding to the second touch,
identify a scroll direction based on the identified left and right hand information,
identify a scroll speed based on a touch area corresponding to the second touch input, and
change a screen displayed based on the identified scroll direction and scroll speed.

11. A method comprising:
displaying a plurality of menu items on a touch display;
based on receiving a touch input to one item among the plurality of menu items, identifying a touch area corresponding to the touch input;
identifying an information depth based on the identified touch area; and
displaying content corresponding to the one item in a layout corresponding to the identified information depth.

12. The method of claim 11, wherein the displaying the content comprises:
based on the touch area being less than a threshold value, displaying content corresponding to the one item in a first layout corresponding to a first depth, and,
based on the touch area being greater than or equal to the threshold value, displaying content corresponding to the one item in a second layout corresponding to a second depth,
wherein a number of the content displayed in the second layout is different from a number of the content displayed in the first layout.

13. The method of claim 11, further comprising:
displaying a guide user interface (UI) for guiding provision of content in a different layout according to a touch area for an area in which the plurality of menu items are displayed.

14. The method of claim 11, wherein the displaying the content comprises:
based on the one item being a calendar item, in response to the touch area being less than a first threshold value, displaying a daily content in a first layout corresponding to a first depth,
in response to the touch area being greater than or equal to the first threshold value and less than a second threshold value, displaying a weekly content in a second layout corresponding to a second depth, and,
in response to the touch area being greater than or equal to the second threshold value, displaying a monthly content in a third layout corresponding to a third depth.

15. The method of claim 11, wherein the displaying the content comprises:
based on the one item being a content list item, in response to the touch area being less than a first threshold value, displaying a text list for a plurality of contents in a first layout corresponding to a first depth,
in response to the touch area being greater than or equal to the first threshold value and less than a second threshold value, displaying a thumbnail and title information of the plurality of contents, and
in response to the touch area being greater than or equal to the second threshold value, displaying an image of the plurality of contents in a third layout corresponding to a third depth.

16. The method of claim 11, wherein the displaying the content comprises:
based on the one item being a content list item, in response to the touch area being less than a first threshold value, displaying a content file list in a first layout corresponding to a first depth,
in response to the touch area being greater than or equal to the first threshold value and less than a second threshold value, displaying a lower folder list in the second layout corresponding to a second depth, and
in response to the touch area being greater than or equal to the second threshold value, displaying an upper folder list in a third layout corresponding to a third depth.

17. The method of claim 11, wherein the displaying the content comprises displaying a fewer number of content as a size of the touch area increases.

18. The method of claim 11, wherein
the touch input is a first touch input, and
the displaying the content comprises:
displaying a user interface to change a layout that corresponds to the identified information depth, and
based on receiving a second touch input on the user interface, identifying a touch area that corresponds to the second touch input and changing the layout based on a touch area that corresponds to the second touch input.

19. The method of claim 11, further comprising:
based on a touch shape that corresponds to the touch input being a palm shape,
identifying a user's body size based on the identified touch area,
identifying a position on a display on which the content is to be displayed based on the identified body size, and
displaying the content in a layout corresponding to the identified information depth on the identified position on the display.

20. The method of claim 11, wherein
a touch input is a first touch input, and
the method further comprises:
based on receiving a second touch input, identifying left and right hand information corresponding to the second touch input and a touch area corresponding to the second touch,
identifying a scroll direction based on the identified left and right hand information,
identifying a scroll speed based on a touch area corresponding to the second touch input, and
changing a screen displayed based on the identified scroll direction and scroll speed.
